(19) United States
(12) Patent Application Publication
(10) Pub. No.: US 2011/0051073 A1
(43) Pub. Date: Mar. 3, 2011

(54) SUNGLASSES FOR EXISTING EYEGLASSES DEVICE

(76) Inventor: Willie Willis, Lakeland, FL (US)

(21) Appl. No.: 12/843,223

(22) Filed: Jul. 26, 2010

Related U.S. Application Data
(60) Provisional application No. 61/237,127, filed on Aug. 26, 2009.

(51) Int. Cl. G02C 7/10; G02C 9/00

(52) U.S. Cl. 351/47

(57) ABSTRACT

A sun shielding device for positioning behind a pair of prescription eyeglasses comprising: a frame, a sun shielding lens, a retaining cord, and a cord adjuster cord lock. The frame and the sun shielding lens are adapted to easily fit behind a pair of eyeglasses. The sun shielding lens is curved and provides peripheral sun protection for the eyes. The elastically deformable retaining cord is connected to the frame and may be tightened or loosened with the cord adjuster cord lock so that the sun shielding device may be tightened against or taken off a user's face. A kit and method of using the sun shielding device is also disclosed herein.

### CROSS-REFERENCE TO RELATED APPLICATION

The present application is related to and claims priority from prior provisional application Ser. No. 61/237,127 filed Aug. 26, 2009 which application is incorporated herein by reference.

### BACKGROUND OF THE INVENTION

1. Field of the Invention

The present invention relates generally to the field of sunglasses which can be worn in combination with prescription eyeglasses and more specifically relates to a sun shielding device for positioning behind a pair of prescription eyeglasses.

2. Description of the Related Art

The use of sunglasses has become more prevalent over the years since sunglasses are not just a popular fashion accessory but there are various health benefits of wearing sunglasses. Sunglasses are recognized as useful for the protection of the eyes against ultraviolet (UV) radiation from sunlight which has been associated with the development of cataracts and age-related macular degeneration (AMD). Additionally, sunglasses reduce eye strain in bright conditions. In very bright conditions, the pupil cannot constrict small enough to reduce light to a comfortable level. This causes a person to squint. Muscle fatigue associated with squinting and constant constriction of the pupil can lead to headaches and eyestrain. Sunglasses further protect the wearer from flying debris and other hazards and reduce the amount of light that reaches the retina to more optimal levels for clear, comfortable vision.

Clear, comfortable vision and optimal protection in different environmental conditions is particularly important for people who engage a lot in outdoor activities. That is one of the reasons why sunglasses have gained increasing acceptance in outdoor sports. Outdoor sports demand strenuous activity and different environmental conditions may lead to visual problems. The basic purpose of sports sunglasses is to protect the eyes from the harmful glare of the sun which not only damages the eyes but also distracts from focusing on the sport and different terrains. When it comes to sports, sunglasses are essential for protecting eyes from injury as well as protecting the eyes from the sun and easing outdoor activities.

Since approximately 30% of adults are nearsighted they often have to purchase a pair of sunglasses or sports sunglasses with prescription lenses. With conventional sunglasses or sports sunglasses, a prescription can be made and corrective lenses mounted in the frame.

Unfortunately, prescription sunglasses or prescription sports sunglasses are costly and it is a hassle to replace them when they get lost. Prescription eyeglasses with front-mount clip-on sunglass lenses may be ineffective as currently manufactured since they often fail to protect the user's peripheral vision because the sunglass lenses may not extend beyond the prescription lenses and thus not provide extended peripheral coverage. Eyeglasses with front-mount clip-on sunglass lenses also have typically no additional means for fitting the sunglasses snugly to the users face so that they do not fall off when the user engages in sporting activities.

Various attempts have been made to solve the above-mentioned problems such as those found in U.S. Pat. Nos. 7,284,853, 6,742,888, 5,321,443, and 4,729,650. This prior art is representative of sunglasses which can be worn in combination with prescription eyeglasses. None of the above inventions and patents, taken either singly or in combination, is seen to describe the invention as claimed.

Ideally, a pair of sunglasses which can be worn in combination with prescription eyeglasses should be comfortable to wear, easy to use, allow the user to engage in sporting activities without risking loosing or having to readjust the pair of sunglasses, comprise a minimum of necessary parts and be manufactured at a modest expense. Thus, a need exists for a reliable pair of sunglasses which can be worn in combination with prescription eyeglasses to avoid the above-mentioned problems.

### BRIEF SUMMARY OF THE INVENTION

In view of the foregoing disadvantages inherent in the known sunglasses which can be worn in combination with prescription eyeglasses art, the present invention provides a novel sun shielding device. The general purpose of the present invention, which will be described subsequently in greater detail, is to provide a user with a novel easily adjustable sun shielding device which can be worn behind a pair of prescription eyeglasses and which protects the peripheral vision. The device may be adjusted and readjusted with a retaining cord to snugly and comfortably fit the user's face, thus assisting the user in effectively participating in athletic activities without risking loosing the sun shielding device. The sun shielding device is curved to protect the user's peripheral vision and snugly fits the users face so that extensive sun protection is provided. This innovative item is ideal for individuals with eyeglasses looking for an efficient way to protect their eyes from the sun while engaging in outdoor activities.

A sun shielding device for positioning behind a pair of eyeglasses is disclosed herein comprising: a frame comprising an inner tangential relationship with the pair of eyeglasses; at least one curved flex-bendable sun shielding lens to create peripheral sun protection for eyes; a first side fastener comprising a u-shaped loop having an aperture providing a retaining cord-engaging means; a second side fastener comprising a u-shaped loop having an aperture providing a retaining cord-engaging means; a sun shielding device center section; at least one tubular or flat retaining nylon cord comprising a first retaining cord end and a second retaining cord end which is elastically deformable to tightly fit to the head of a user; and a cord adjuster cord lock.

In the present invention, the frame receives the sun shielding lens and the sun shielding device center section, thereby forming a unit. The sun shielding device center section may rest on the nose pad arms of the pair of eyeglasses, thus allowing the sun shielding lens to rest between the nose pads and lenses of the pair of eyeglasses. The user may simply slide the sun shielding lens between each of the nose pads and the lenses of the pair of eyeglasses. The sun shielding device center section may also comprise an attacher for removably attaching the sun shielding device to the bridge of the pair of eyeglasses to additionally limit unwanted displacement of the sun shielding device. The frame may further comprise an integral first side fastener and an integral second side fastener which are located on opposing ends of the frame. The two retaining cord ends of the retaining cord are preferably connected to the two side fasteners. The retaining cord may be tightened or loosened with a cord adjuster cord lock so that the sun shielding device is tightened against or taken off a user's face, according to user preference.

A kit is also described herein including a frame, a sun shielding lens, a retaining cord having a cord adjuster cord lock. The kit may include a set of user instructions.

In accordance with the embodiments of the present invention a preferred method of using a sun shielding device is also disclosed herein preferably comprising the steps of: sliding a sun shielding device behind a pair of eyeglasses such that the sun shielding device center section may rest on top of nose pads (or preferably on the nose pad arms) of the pair of eyeglasses and a sun shielding lens may rest between the nose pads and the lenses of the pair of eyeglasses; adjusting a cord adjuster to tighten a retaining cord so that the sun shielding device is tightened against a user's face or adjusting the cord adjuster to loosen the retaining cord so that the sun shielding device is removable from the user's face. Further, additionally securing may be achieved by mounting the sun shielding device to the pair of eyeglasses by attaching the sun shielding device to the bridge of the pair of eyeglasses with an attacher situated on the sun shielding device center section.

The present invention holds significant improvements and serves as a sun shielding device. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, sunglasses for existing eyeglasses device, constructed and operative according to the teachings of the present invention.

FIG. 1 shows a perspective view illustrating a sunglasses for existing eyeglasses device in an ‘in-use condition’ according to an embodiment of the present invention.

FIG. 2 is another perspective view illustrating the sunglasses for existing eyeglasses device in an ‘in-use condition’ according to an embodiment of the present invention of FIG. 1.

FIG. 3 is a perspective view illustrating the sunglasses for existing eyeglasses device according to an embodiment of the present invention of FIGS. 1 and 2.

FIG. 4 is a perspective view illustrating the sunglasses for existing eyeglasses device attached to a pair of eyeglasses according to an embodiment of the present invention of FIGS. 1-3.

FIG. 5 is a flowchart illustrating a method of use according to an embodiment of the present invention of FIGS. 1-4.

The various embodiments of the present invention will hereinafter be described in conjunction with the appended drawings, wherein like designations denote like elements.

### DETAILED DESCRIPTION

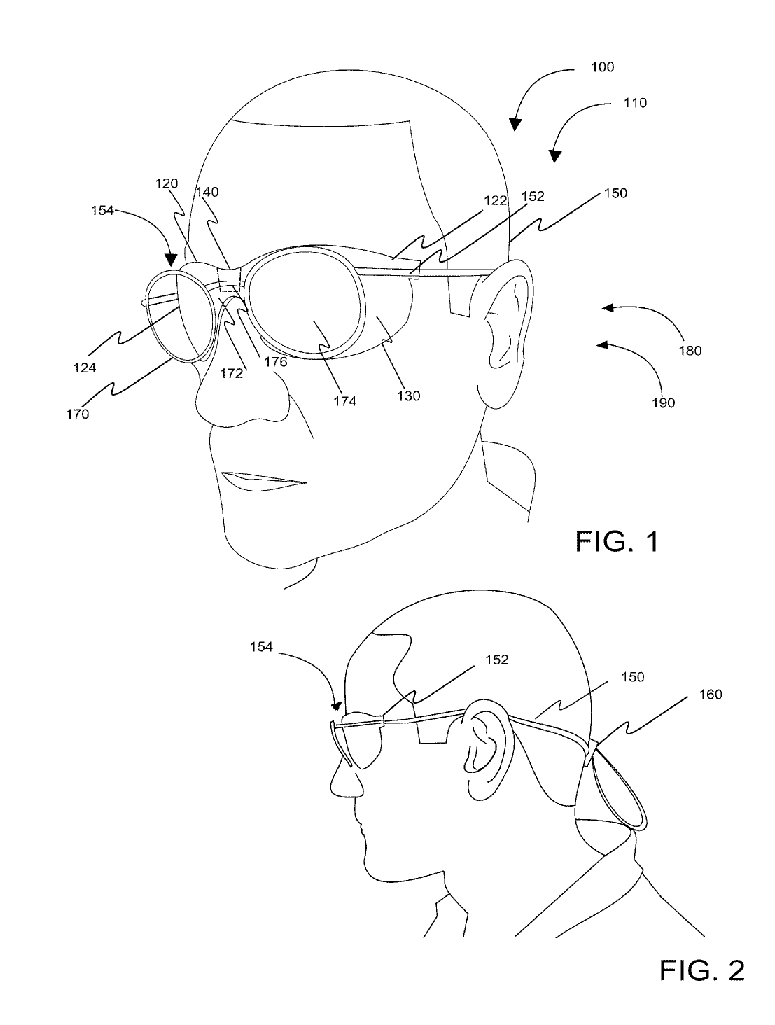

As discussed above, embodiments of the present invention relate to sunglasses which can be worn in combination with prescription eyeglasses and more particularly as a sun shielding device for positioning behind a pair of prescription eyeglasses as used to improve the sun protection for users with prescription eyeglasses. The sunglasses for existing eyeglasses device provides a user with an effective means to simultaneously use prescription eyeglasses and sunglasses without risking loosing the sunglasses while engaging in various rigorous activities. Now, referring to the drawings by numerals of reference there is shown in FIGS. 1 and 2, a perspective view illustrating sunglasses for existing eyeglasses device 100 in an in-use condition 190 according to an embodiment of the present invention.

FIGS. 1 and 2 illustrate user 180 wearing sunglasses for existing eyeglasses device 100 in combination with a pair of eyeglasses 170. Sunglasses for existing eyeglasses device 100 preferably comprises at least one sun shielding device 110 preferably comprising frame 120, sun shielding lens 130, first side fastener 122, second side fastener 124, sun shielding device center section 140, retaining cord 150 (comprising first retaining cord end 152 and second retaining cord end 154) and cord adjuster 160. In certain embodiments retaining cord 150 may be epoxied to sun shielding lens 130. It should be appreciated that other fastening means other than epoxy may be used, such as other adhesives, mechanical fastening means, magnets or other suitable alternatives.

Frame 120 may be affixed to at least one sun shielding lens 130 and sun shielding device center section 140 to create sun shielding device 110. User 180 may slide sun shielding device 110 behind pair of eyeglasses 170 of user 180 such that sun shielding device center section 140 may rest on nose pads 172 (or preferably nose pad arms) of pair of eyeglasses 170 and sun shielding lens 130 may rests between nose pads 172 and lenses 174 of pair of eyeglasses 170. In certain embodiments, frame 120, sun shielding lens 130 and sun shielding device center section 140 may comprise one single piece. In other embodiments frame 120, sun shielding lens 130 and sun shielding device center section 140 may comprise multiple pieces/components. Retaining cord 150 may be attached to frame 120 and may be tightened or loosened with cord adjuster 160 such that sun shielding device 110 is tightened against or taken off user's 180 face to create in-use-condition 190 as shown in the present figures.

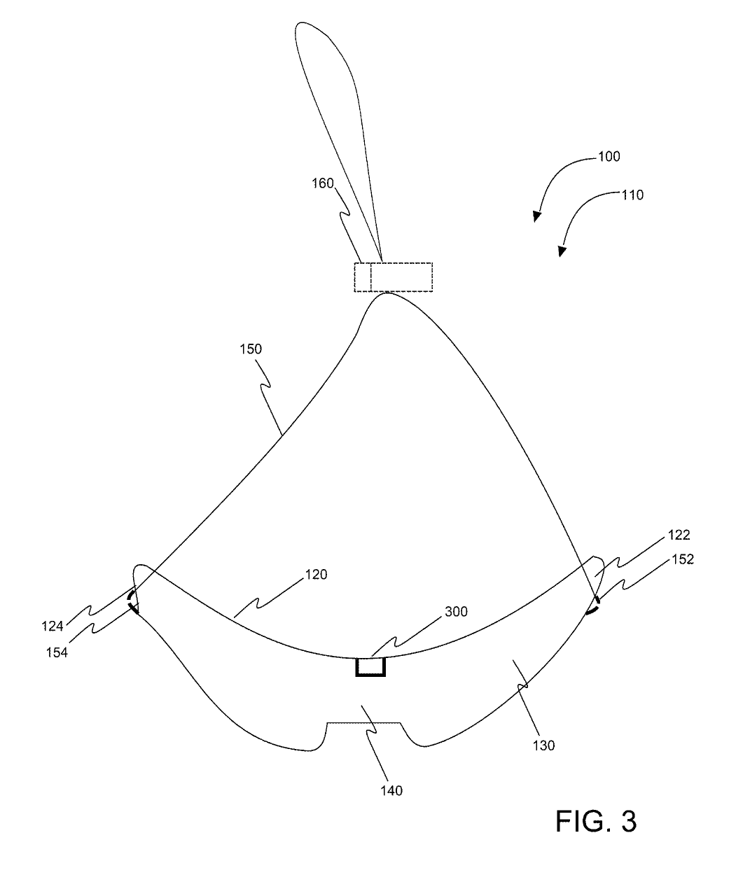

Referring now to FIG. 3 showing a perspective view illustrating a sun shielding device 110 according to an embodiment of the present invention of FIGS. 1 and 2.

As described previously, sun shielding device 110 preferable comprises frame 120. Frame 120 of the present embodiment may be constructed of a semi rigid, flexible and lightweight material and may be curved to conform substantially to the general curvature of user's 180 face in the eye region and to snugly fit adjacent user's 180 face. Frame 120 may comprise an inner tangential relationship with pair of eyeglasses 170. The upper edge portion of sun shielding lens 130 and sun shielding device center section 140 may be affixed to frame 120, thereby forming sun shielding device 110 which may fit behind pair of eyeglasses 170. In certain embodiments, frame 120, sun shielding lens 130 and sun shielding device center section 140 may comprise one single piece. It should be appreciated that the present invention fits adjacent the face of a user 180 such that glare and UV-rays are greatly reduced over that of typical sunglasses presently available. The close proximity provides enhanced protection from the sun.

Frame 120 comprises first side fastener 122 and second side fastener 124 which are preferably integral and located on opposing ends of frame 120. First side fastener 122 and second side fastener 124 each preferably comprise a u-shaped loop having an aperture providing a retaining cord-engaging means. First side fastener 122 and second side fastener 124 used within the present invention each preferably comprise suitable durable material. First side fastener 122 and second side fastener 124 may be comprised of various retaining cord 150 securing means of various shapes such as loops, hooks, staples, etc. First side fastener 122 and second side fastener 124 each are of sufficient size to receive first retaining cord end 152 and second retaining cord end 154 which may be attached to first side fastener 122 and second side fastener 124.

Sun shielding lens 130 may include sun shielding device center section 140 and may be affixed to frame 120. In other embodiments frame 120, sun shielding device center section 140, and sun shielding lens 130 may comprise one piece. Sun shielding lens 130 may be curved to provide eye protection from sunlight peripherally at the side edges of sun shielding lens 130. In a preferred embodiment, sun shielding lens 130 in horizontal cross section preferably defines an arc. Sun shielding lens 130 may be flex-bendable to snugly fit user's 180 face and to provide eye protection from sunlight at the top and bottom edge of sun shielding lens 130. Further, the flex-bendable characteristic provides for durable cost-effective use when playing vigorous sports, especially upon impact. Sun shielding lens 130 is preferably made of a tinted, thin, lightweight, flexible plastic material. However, sun shielding lens 130 may be comprised of other suitable materials, such as shatterproof glass, etc.

Sun shielding lens(es) 130 comprise sun shielding device center section 140 which may be situated in the center of sun shielding lens 130 and which may be adapted to rest on nose pads 172 (or preferably nose pad arms) of pair of eyeglasses 170. Sun shielding device center section 140 forms an integral nosepiece of sun shielding lens 130 and is of sufficient size to fit behind a bridge and on top of nose pads 172 (or preferably nose pad arms) of pair of eyeglasses 170. Sun shielding device center section 140 may form a nose opening area of sun shielding lens 130 thereby providing a means for resting sun shielding device 110 on top of arms of nose pads 172 of pair of eyeglasses 170 and allowing sun shielding lens 130 to rest between nose pads 172 (or preferably nose pad arms) and lenses 174 of pair of eyeglasses 170. User may simply slide sun shielding device 110 on top and behind nose pads 172 of pair of eyeglasses 170. Alternatively, sun shielding device 110 may be positioned on user's 180 nose without attaching sun shielding device 110 to pair of eyeglasses 170. Sun shielding lens 130 is smoothly rounded thereby eliminating sharp edges or corners and providing comfort and safety to user 180.

In certain embodiments sun shielding device center section 140 may further comprise attacher 300 to enable removable attachment of sun shielding device 110 to bridge 176 of pair of eyeglasses 170 and to additionally limit unwanted displacement of sun shielding device 110. Attacher 300 preferably comprises a clip. The clamping force of the clip will substantially insure that sun shielding device 110 will remain in position. The clip further allows user 180 to detach sun shielding device 110 from pair of eyeglasses 170 at any time. However, attacher 300 may comprise various attaching means such as hooks, etc.

Retaining cord 150 in this particular embodiment preferably comprises an elastic nylon cord comprising a tubular profile having an outer circumference (or an elastic cord with a rubber core and a stretchable fabric/nylon covering). However, retaining cord 150 may comprise other flexible material such as rubber, leather, etc and may comprise a flat instead of a tubular shape. In the preferred embodiment, retaining cord 150 has a diameter such that it may be easily passed through first side fastener 122 and second side fastener 124. Retaining cord 150 securely retains sun shielding device 110 and yet is very light and comfortable. However, retaining cord 150 may be shortened or lengthened according to user 180 size and preference. Retaining cord 150 preferably comprises first retaining cord end 152 and a second retaining cord end 154 wherein first retaining cord end 152 is passed through first side fastener 122 and tied to first side fastener 122 preferably with a knot and second retaining cord end 154 is passed through second side fastener 124 and tied to second side fastener 124 with a knot thereby securing retaining cord 150 to frame 120. Retaining cord 150 may be elastically deformable to tightly fit head of user 180 when in use. Retaining cord 150 may also be used to hang the sunglasses for existing eyeglasses device 100 about user's 180 neck when not in use.

Sun shielding device 110 may be tightened to user's 180 eye region and head by adjusting retaining cord 150 with cord adjuster 160. Cord adjuster 160 may comprise cord adjuster cord lock wherein the cord adjuster cord lock is used to tighten or loosen retaining cord 150. Cord adjuster cord lock may preferably be made of plastic, be lightweight, small, and preferably comprise a cord lock model with a main body which is cylindrically shaped, including a hole in the side through which the retaining cord 150 may be passed, and a button which can be squeezed to release the retaining cord 150. However, cord adjuster 160 may comprise virtually any type of cord lock and may be comprised of other suitable materials, such as wood, rubber, etc. Retaining cord 150 may be folded and threaded through the hole of cord adjuster 160. Tightening or loosening retaining cord 150 is accomplished by squeezing the button of cord adjuster 160 and sliding cord adjuster 160 up and down retaining cord 150. By releasing the button of cord adjuster 160, cord adjuster 160 locks itself in place. User 180 may alternatively tighten or loosen retaining cord 150, thereby tighten sun shielding device 110 against user's 180 face or remove sun shielding device 110 from user's 180 face. On tightening retaining cord 150 a snugly and tight fit of sun shielding device 110 will then be achieved and user 180 will be able to engage in (sports) activities without fear of loosing sunglasses for existing eyeglasses device 100. The present invention provides that sunglasses for existing eyeglasses device 100 may be exclusively held in place via retaining cord 150.

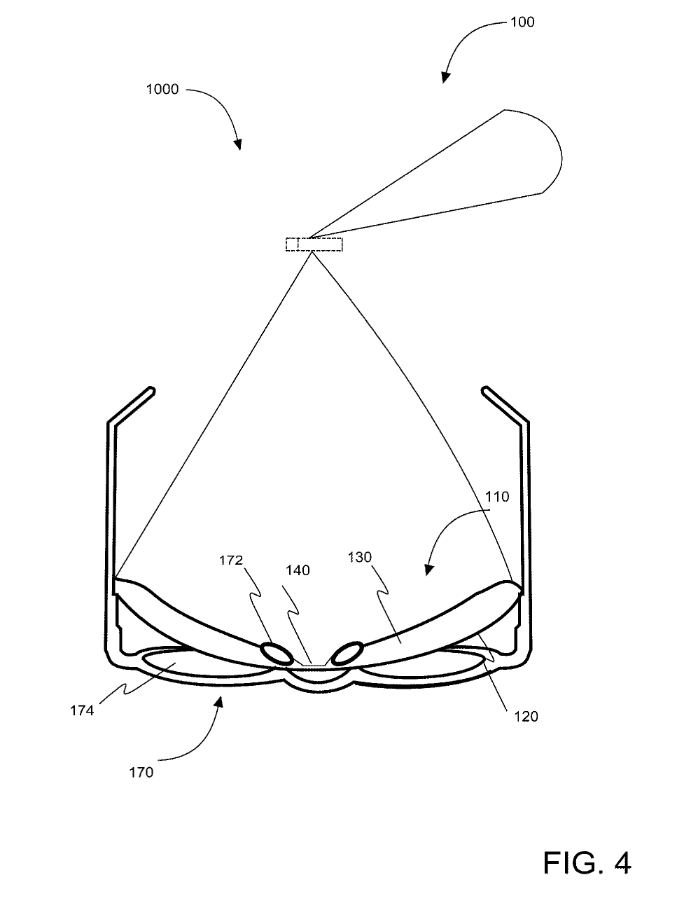

Referring now to FIG. 4, illustrating sun shielding device 110 attached to a pair of eyeglasses 170 according to an embodiment of the present invention of FIGS. 1-3.

Frame 120 and sun shielding lens 130 within this particular embodiment comprise an inner tangential relationship with pair of eyeglasses 170. Sun shielding device center section 140 may rest on top of nose pads 172 (or preferably nose pad arms) of pair of eyeglasses 170 and sun shielding lens 130 may rest between nose pads 172 and lenses 174 of pair of eyeglasses 170 thereby creating a connection between eyeglasses 170 and sun shielding device 110. Sun shielding lens 130 is curved to protect user's 180 peripheral vision and to conform the curvature of user's 180 face. Sun shielding lens 130 and frame 120 in horizontal cross section define an arch thereby allowing sun shielding lens 130 to be placed behind pair of eyeglasses 170 and to snugly fit user's 180 face. Since pair of eyeglasses 170 generates a substantially straight line and sun shielding device 110 is curved, pair of eyeglasses 170 and sun shielding device 110 only touch/connect at the sun shielding device center section 140 and nose pads 172 within the particular embodiment of FIG. 4. The FIG. 4 embodiment demonstrates where there may be more points of contact. Sun shielding lens 130 and frame 120 preferably extend from sun shielding device center section 140 inwardly towards user's 180 face and away from pair of eyeglasses 170 and lenses 174 at such a favorable angle thereby snugly fitting user's 180 face and preventing sun shielding device 110 and sun shielding lens 130 from interfering with pair of eyeglasses 170 and lenses 174. Sun shielding lens 130 preferably comprises a slightly smaller width than pair of eyeglasses 170 to easily fit behind pair of eyeglasses 170. As previously mentioned, sun shielding device 110 may be attached to pair of eyeglasses 170 by sliding sun shielding lens 130 between nose pads 172 and lenses 174 of pair of eyeglasses 170, or by attaching sun shielding device 110 with attacher 300 placed at sun shielding device center section, 140 or sun shielding device 110 may not be attached to pair of eyeglasses 170 at all.

Sunglasses for existing eyeglasses device 100 may be sold as kit 1000 comprising the following parts: at least one frame 120, at least one sun shielding lens 130, at least one retaining cord 150 optionally having at least one cord adjuster 160, and at least one set of user instructions. Sunglasses for existing eyeglasses device 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient.

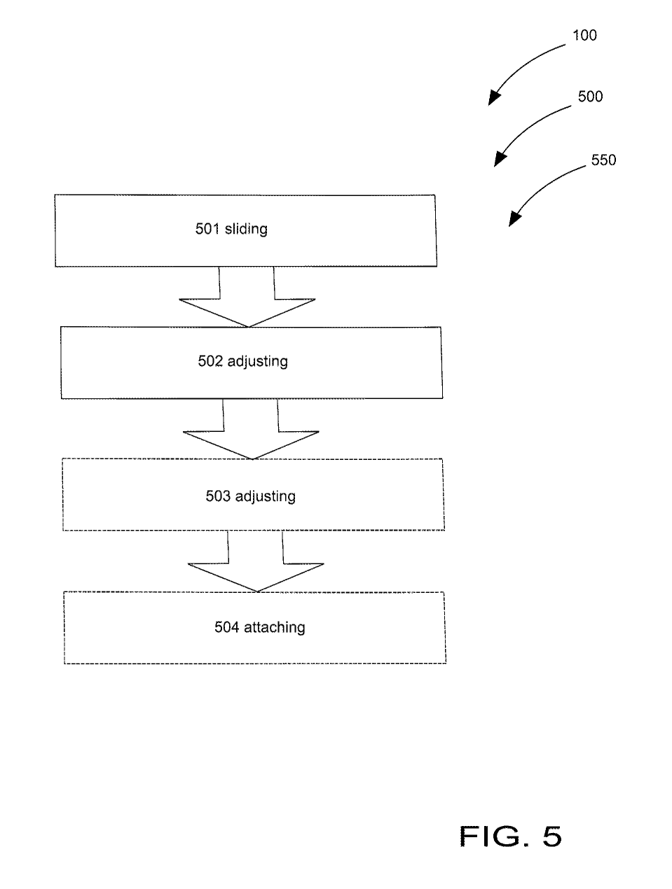

Referring now to FIG. 5, showing flowchart 550 illustrating a method of use 500 according to an embodiment of the present invention of FIGS. 1-4.

In accordance with the embodiments of the present invention a preferred method of use 500 is disclosed herein comprising the following steps: step one 501 sliding sun shielding device 110 behind pair of eyeglasses 170 so that sun shielding device center section 140 may rest on top of nose pads 172 (or preferably nose pad arms) of pair of eyeglasses 170 and sun shielding lens 130 may rest between nose pads 172 and lenses 174 of pair of eyeglasses 170; step two 502 adjusting cord adjuster 160 to tighten retaining cord 150 so that sun shielding device 110 is tightened against user's 180 face; and step three 503 optionally adjusting cord adjuster 160 to loosen retaining cord 150 so that sun shielding device 110 is removed from user's 180 face.

The method of using the sunglasses for existing eyeglasses device 100 may further include step four 504, attaching sun shielding device 110 to bridge 176 of pair of eyeglasses 170 with attacher 300 situated at sun shielding device center section 140.

It should be noted that steps three 503 and four 504 are optional steps and may not be implemented in all cases. Optional steps of method of use 500 are illustrated using dotted lines in FIG. 5 so as to distinguish them from the other steps of method of use 500.

It should be noted that the steps described in the method of use can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

1. A sun shielding device for positioning behind a pair of eyeglasses comprising:
a frame;
at least one sun shielding lens;
a first side fastener;
a second side fastener;
a sun shielding device center section;
at least one retaining cord comprising a first retaining cord end and a second retaining cord end; and
a cord adjuster;
wherein said frame receives said at least one sun shielding lens and said sun shielding device center section allowing said sun shielding device center section to rest on top of nose pad arms of said pair of eyeglasses and thereby allowing said at least one sun shielding lens to rest between said nose pads and lenses of said pair of eyeglasses;
wherein said first side fastener and said second side fastener are integral and are located on opposing ends of said frame;
wherein said first retaining cord end is connected to said first side fastener;
wherein said second retaining cord end is connected to said second side fastener;
wherein said cord adjuster is used to tighten or loosen said retaining cord so that said sun shielding device is tightened against or taken off a user's face.

2. The sun shielding device for positioning behind a pair of eyeglasses of claim 1 wherein said frame comprises an inner tangential relationship with said pair of eyeglasses thereby creating a sun shielding means for a user-wearer.

3. The sun shielding device for positioning behind a pair of eyeglasses of claim 1 wherein said sun shielding lens is curved so as to create peripheral sun protection for the eyes of a user-wearer.

4. The sun shielding device for positioning behind a pair of eyeglasses of claim 3 wherein said sun shielding lens is flex-bendable.

5. The sun shielding device for positioning behind a pair of eyeglasses of claim 1 wherein said first and second side fasteners each comprise a u-shaped loop.

6. The sun shielding device for positioning behind a pair of eyeglasses of claim 5 wherein said u-shaped loop comprises an aperture providing a retaining cord-engaging means.

7. The sun shielding device for positioning behind a pair of eyeglasses of claim 1 wherein said retaining cord comprises nylon.

8. The sun shielding device for positioning behind a pair of eyeglasses of claim 7 wherein said retaining cord is elastically deformable to tightly fit to head of a user-wearer.

9. The sun shielding device for positioning behind a pair of eyeglasses of claim 1 wherein said retaining cord comprises a flat profile.

10. The sun shielding device for positioning behind a pair of eyeglasses of claim 1 wherein said retaining cord comprises a tubular profile having an outer circumference.

11. The sun shielding device for positioning behind a pair of eyeglasses of claim 1 wherein said cord adjuster comprises a cord lock.

12. The sun shielding device for positioning behind a pair of eyeglasses of claim 1 wherein said sun shielding device center section further comprises an attacher for removably attaching said sun shielding device to a bridge of the pair of eyeglasses to limit unwanted displacement of said sun shielding device.

13. The sun shielding device for positioning behind a pair of eyeglasses of claim 1 wherein said retaining cord is epoxied to said sun shielding lens.

14. A sun shielding device for positioning behind a pair of eyeglasses comprising:
a frame comprising an inner tangential relationship with said pair of eyeglasses thereby creating a sun shielding means for a user;
at least one curved flex-bendable sun shielding lens to create peripheral sun protection for the eyes;
a first side fastener comprising a u-shaped loop having an aperture providing a retaining cord-engaging means;
a second side fastener comprising a u-shaped loop having an aperture providing a retaining cord-engaging means;
a sun shielding device center section comprising an attacher for removably attaching said sun shielding device to a bridge of said pair of eyeglasses to limit unwanted displacement of said sun shielding device;
at least one tubular or flat retaining nylon cord comprising a first retaining cord end and a second retaining cord end which is elastically deformable to tightly fit to head of said user; and
a cord adjuster cord lock;
wherein said frame receives said at least one of said sun shielding lens and said sun shielding device center section allowing said sun shielding device center section to rest on top of nose pad arms of said pair of eyeglasses and allowing said at least one sun shielding lens to rest between said nose pads and lenses of said pair of eyeglasses;
wherein said first side fastener and said second side fastener are integral and are located on opposing ends of said frame;
wherein said first retaining cord end is connectable to said first side fastener;
wherein said second retaining cord end is connectable to said second side fastener;
wherein said cord adjuster cord lock is used to tighten or loosen said retaining cord so that said sun shielding device is tightened against or taken off a user's face.

15. The sun shielding device for positioning behind a pair of eyeglasses of claim 14 wherein said sun shielding device for positioning behind a pair of eyeglasses comprises a kit including said frame, said sun shielding lens, said retaining cord having a said cord adjuster cord lock, and a set of user instructions.

16. A method of using a sun shielding device for positioning behind a pair of eyeglasses comprising the steps of:
sliding a sun shielding device behind a pair of eyeglasses so that a sun shielding device center section may rest on top of nose pad arms of said pair of eyeglasses and a sun shielding lens may rest between said nose pads and lenses of said pair of eyeglasses;
adjusting a cord adjuster to tighten a retaining cord such that said sun shielding device is tightened against a user's face;
adjusting said cord adjuster to loosen said retaining cord such that said sun shielding device is removed from said user's face.

17. The method of using said sun shielding device of claim 16 further comprising the step of:
attaching said sun shielding device to a bridge of said pair of eyeglasses with an attacher situated on said sun shielding device center section.
